(19) United States
(12) Patent Application Publication
(10) Pub. No.: US 2014/0099095 A2
(43) Pub. Date: Apr. 10, 2014

(54) A ROTATABLE FLASH TRIGGER

(71) Applicants: Yuan Bo Chen, Guangdong Province (CN); Hung Lok Poon, Kln (HK)

(72) Inventors: Yuan Bo Chen, Guangdong Province (CN); Hung Lok Poon, Kln (HK)

(73) Assignee: Phottix HK Ltd., Kln (HK)

(21) Appl. No.: 13/558,800

(22) Filed: Jul. 26, 2012

(30) Foreign Application Priority Data
May 4, 2012 (CN) 201220195258.8

(51) Int. Cl. G03B 17/56

(52) U.S. Cl. 396/544

(57) ABSTRACT

A rotatable flash trigger is disclosed. The rotatable flash trigger may include a hot shoe connector, a trigger body, and a rotation mechanism positioned between the trigger body and the hot shoe connector. The trigger body may be configured to rotate with respect to one axis or multiple axes. Additionally, a surface of the trigger body may include a hot shoe receptor.

### CROSS REFERENCE TO RELATED APPLICATIONS

This application claims priority of Chinese application CN201220195258.8 filed on May 4, 2012, the contents of which are incorporated fully herein by reference.

### FIELD OF THE INVENTION

The present invention relates to the field of camera and flash control technology and, more particularly, to flash triggers capable of rotating.

### BACKGROUND OF THE INVENTION

Camera and flash control technology utilize hot shoe connectors in order to attach powered accessories to the cameras. There is an ever-present need for camera accessories that can improve picture quality while being able to be stored compactly.

### SUMMARY OF THE INVENTION

The present invention is embodied in a flash trigger capable of rotating while attached to a camera. The rotatable flash trigger may include a hot shoe connector, a trigger body, and a rotation mechanism positioned between the trigger body and the hot shoe connector. The trigger body may be configured to rotate with respect to one axis or multiple axes. Additionally, a surface of the trigger body may include a hot shoe receptor.

### BRIEF DESCRIPTION OF THE DRAWINGS

The invention is best understood from the following detailed description when read in connection with the accompanying drawings, with like elements having the same reference numerals. This emphasizes that according to common practice, the various features of the drawings are not drawn to scale. On the contrary, the dimensions of the various features are arbitrarily expanded or reduced for clarity. Included in the drawings are the following figures:

FIG. 1 is a perspective view of a flash trigger with a rotatable hot shoe connector in accordance with one aspect of the present invention;

FIG. 2 is an exploded view of the flash trigger of FIG. 1;

FIGS, 3A and 3B are illustrations demonstrating rotation of a flash trigger about different axes.

FIG. 4 is a perspective view of another flash trigger with a rotatable hot shoe connector including a hot shoe receptor in accordance with one aspect of the present invention.

### DETAILED DESCRIPTION OF THE INVENTION

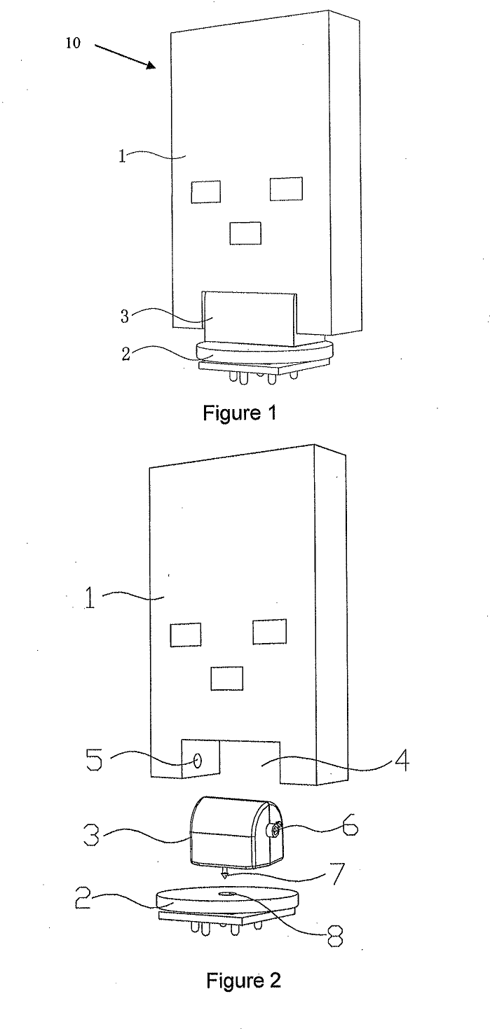

FIG. 1 illustrates an assembled rotatable flash trigger 10 in accordance with one embodiment of the present invention. The illustrated flash trigger 10 includes a trigger body 1, a hot shoe connector 2, and a rotation mechanism 3. The hot shoe connector 2 may be connected to corresponding hot shoe connectors (referred to herein as hot shoe receptors) such as those found on conventional cameras.

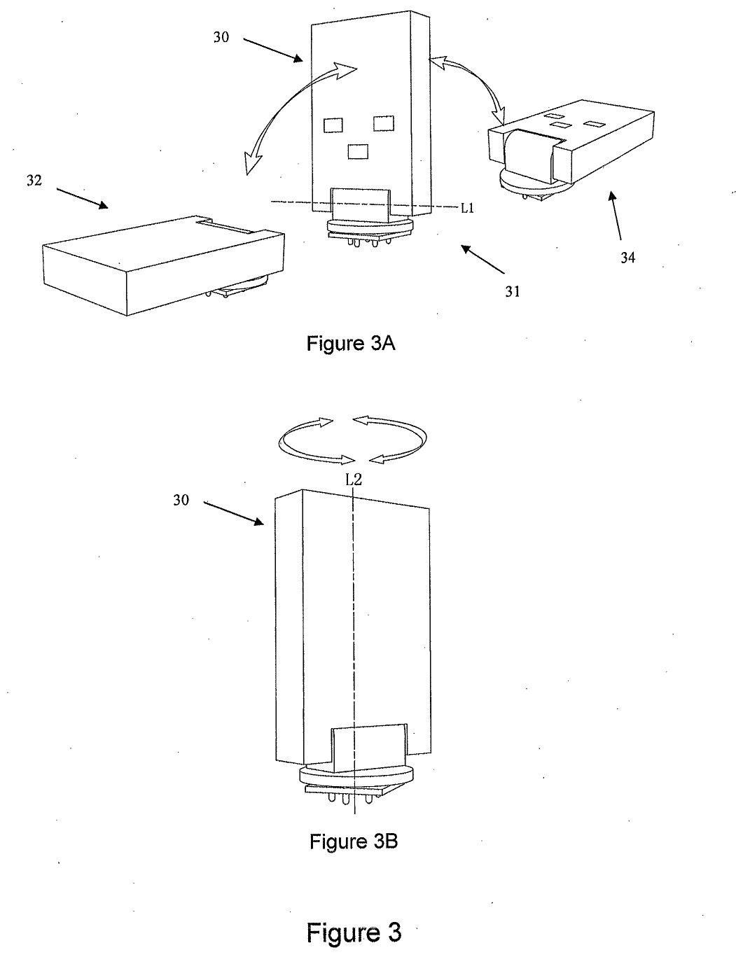

FIG. 2 illustrates the flash trigger 10 separated into various components. The trigger body 1 may contain an electronic element, such as a flash, a trigger mechanism, a transmitter, or other components conventionally found in flash triggers. The trigger body 1 may be connected to the hot shoe connector 2 through the rotation mechanism 3. The illustrated trigger body 1 includes a groove 4 configured to receive the rotation mechanism 3. The illustrated groove 4 is rectangular, however, it may have other shapes, e.g. square, cylindrical, spherical, etc. At least one bearing connector 5 is positioned on the trigger body 1 within the area inside the groove 4. The bearing connector 5 is configured to engage a corresponding connector on the rotation mechanism 3 for rotation about one axis. Although not depicted, the illustrated trigger body 1 includes another bearing connector within the groove 4 on the side opposite of the side containing bearing connector 5.

The illustrated hot shoe connector 2 includes at least one bearing connector 8. The bearing connector 8 is configured to engage a corresponding connector on the rotation mechanism 3 to form a hinge for rotation about one axis.

The illustrated rotation mechanism 3 is positioned between the trigger body 1 and the hot shoe connector 2 to enable rotation of the trigger body 1 about multiple axes. In alternative embodiments, the positioning of the rotation mechanism 3 between the trigger body 1 and the hot shoe connector 2 enables rotation of the trigger body 1 about one axis. The illustrated rotation mechanism 3 includes bearing connectors 6, 7 configured to engage corresponding connectors on the trigger body 1 and hot shoe connector 2, respectively, to form a pair of hinges for rotation about two axes. Other rotation mechanisms may be employed, e.g., a revolving shaft, a slotted hinge, a spring click, a wheel gear, etc. In an embodiment where the trigger body 1 contains an electronic element, the rotation mechanism 3 may be configured to electrically couple the electronic element in the trigger body 1 to the hot shoe connector 2. In embodiments where the trigger body 1 includes a groove 4, the shape of the rotation mechanism 3 may compliment the shape of the groove 4 in order to facilitate rotation. The rotation mechanism 3 may have other shapes, e.g., square, cylindrical, spherical, etc.

The illustrated rotation mechanism 3 includes a bearing connector 6. Although not depicted, the illustrated rotation mechanism 3 includes a second bearing connector on the side opposite to the side containing the bearing connector 6. In the illustrated embodiment, the trigger body 1 includes a bearing connector 5, and bearing connector 6 on the rotation mechanism 3 may be of a type such that when bearing connector 6 engages bearing connector 5, a bearing is formed; i.e. in an embodiment where the bearing connector 5 on the trigger body 1 is a socket, the bearing connector 6 on the rotation mechanism 3 may be a pivot configured to engage the socket on the trigger body 1, or, in an alternative embodiment where the bearing connector 5 on the trigger body 1 is a pivot, the bearing connector 6 on the rotation mechanism 3 may be a socket configured to engage the pivot on the trigger body 1. The illustrated rotation mechanism 3 includes a bearing connector 7. In the illustrated embodiment, the hot shoe connector 2 includes a bearing connector 8. The bearing connector 7 on the rotation mechanism 3 is of a type such that when bearing connector 7 engages bearing connector 8, a bearing is formed; i.e. in an embodiment where the bearing connector 8 on the hot shoe connector 2 is a rotation shaft socket, bearing connector 7 on the rotation mechanism 3 may be a rotation shaft configured to engage the rotation shaft socket on the hot shoe connector 2, or, in an alternative embodiment where the bearing connector 8 on the hot shoe connector 2 is a rotation shaft, the bearing connector 7 on the rotation mechanism 3 may be a rotation shaft socket configured to engage the rotation shaft on the hot shoe connector 2.

FIG. 3A illustrates rotation of the trigger body 1 about one axis where the rotation mechanism 3 enables the trigger body 1 to rotate with respect to axis L1. Advantageously, the trigger body 1 can be rotated to enable storage of a camera (not depicted) without disconnection of the flash trigger 30. The trigger body 1 may be rotated about 90 degrees from an upright position 31 to a first down position 32. Additionally, the trigger body 1 in the illustrated embodiment may be rotated about 90 degrees from an upright position 31 to a second down position 34. In an alternative embodiment, the trigger body 1 may be rotated from a first down position 32 to a second down position 34. FIG. 3B illustrates rotation of the trigger body 1 about one axis where the rotating mechanism 3 enables the trigger body 1 to rotate with respect to axis L2. In a particular embodiment, the flash trigger 30 may rotate with respect to both axis L1 and axis L2. However, the axes on which the flash trigger 30 can rotate are not limited to axis L1 and axis L2 in other embodiments. For example, in a particular embodiment where the shape of the rotating mechanism 3 is hemispherical and the shape of a groove 4 is hemispherical, the flash trigger 30 may rotate with respect to spherical axes.

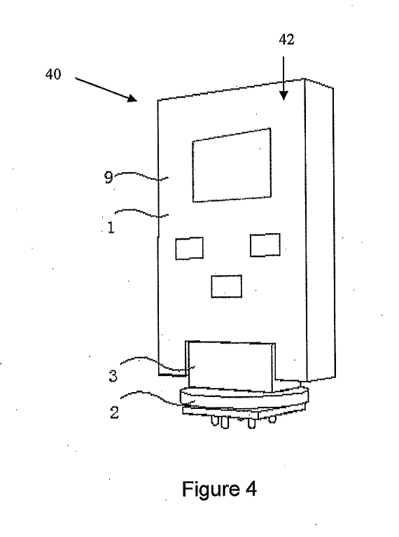

FIG. 4 illustrates a rotatable flash trigger 40 in accordance with another embodiment of the present invention. Flash trigger 40 is similar to flash trigger 10 and 30 with the addition of at least one hot shoe receptor 9. The illustrated hot shoe receptor 9 is on a surface 42 of the rotatable flash trigger 40. In one embodiment, the flash trigger 40 may rotate about one axis. In another embodiment, the flash trigger 40 may rotate about multiple axes. In embodiments where the shape of the rotating mechanism 3 allows for the flash trigger 40 to rotate with respect to axis L1 (FIG. 3) or similar axes, a flash (not shown) may be mounted to the hot shoe receptor 9 when the trigger body 1 is rotated to a position such that the surface 42 is perpendicular to the rotation axis. A flash device (not shown) may be connected to the hot shoe receptor 9.

Embodiments of rotatable flash triggers such as those described above allow for convenient operation of complex photographic scenarios while allowing for compact storage of cameras or similar devices connected to the flash triggers. Additionally, those skilled in the art will recognize that other devices can benefit advantageously from the utilization of the rotation mechanisms described above.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A flash trigger comprising:
a trigger body having an electronic element;
a hot shoe connector; and
a rotation mechanism coupled between the trigger body and the hot shoe connector such that the trigger body is rotatable about at least one axis with respect to the hot shoe connector, the rotation mechanism operable to connect the electronic element to the hot shoe receptor.

2. The trigger of claim 1, wherein the range of rotation of the trigger body is about 90 degrees about the at least one axis.

3. The trigger of claim 1, wherein:
the trigger body includes a first bearing connector; and
the rotation mechanism includes a second bearing connector configured to engage the first bearing connector.

4. The trigger of claim 3, wherein the first and second bearing connectors form a hinge for rotation about the at least one axis.

5. The trigger of claim 1, wherein:
the hot shoe connector includes a first bearing connector; and
the rotation mechanism includes a second bearing connector configured to engage the first bearing connector.

6. The trigger of claim 5, wherein the first and second baring connectors form a hinge for rotation about the at least one axis.

7. The flash trigger of claim 1, wherein the trigger body includes at least one groove, the groove includes a first bearing connector and the rotation mechanism includes a second bearing connector configured to engage with the first bearing connector.

8. The trigger of claim 7, wherein the first and second bearing connectors form a hinge for rotation about at least one axis.

9. The trigger of claim 1, wherein the trigger body includes a surface, the surface of the trigger body containing at least one hot shoe receptor.

10. A flash trigger comprising:
a trigger body having an electronic element;
a hot shoe connector; and
a rotation mechanism coupled between the trigger body and the hot shoe connector such that the trigger body is rotatable about multiple axes with respect to the hot shoe connector, the rotation mechanism operable to connect the electronic element to the hot shoe receptor.

11. The trigger of claim 10, wherein:
the trigger body includes a first bearing connector;
the hot shoe connector includes a second bearing connector; and
the rotation mechanism includes a third bearing connector and a fourth bearing connector, the third bearing connector configured to engage the first bearing connector and the fourth bearing connector configured to engage the second bearing connector.

12. The trigger of claim 11, wherein the first and third bearing connectors form a first hinge for rotation about a first axis and the second and fourth bearing connectors form a second hinge for rotation about a second axis.

13. The trigger of claim 12, wherein the first bearing connector comprises at least one socket and the third bearing connector comprises at least one pivot configured for insertion in the at least one socket.

14. The trigger of claim 12, wherein the first bearing connector comprises at least one pivot and the third bearing connector comprises at least one socket, the at least one pivot configured for insertion in the at least one socket.

15. The trigger of claim 12, wherein the second bearing connector comprises at least one rotation shaft socket and the fourth bearing connector comprises at least one rotation shaft configured for insertion in the at least one rotation shaft socket.

16. The trigger of claim 12, wherein the second bearing connector comprises at least one rotation shaft and the fourth bearing connector comprises at least one rotation shaft socket, the at least one rotation shaft configured for insertion in the at least one rotation shaft socket

17. The trigger of claim 10, wherein the trigger body includes at least one groove, the groove includes a first bearing connector and the rotation mechanism includes a second bearing connector configured to engage with the first bearing connector.

18. The trigger of claim 17, wherein the first and second bearing connectors form a first hinge for rotation about a first axis.

19. The trigger of claim 17, wherein the shape of at least one groove is hemispherical and the shape of the rotating mechanism is hemispherical.

20. The trigger of claim 10, wherein the trigger body includes a surface, the surface of the trigger body containing at least one hot shoe receptor.
